(19) United States
(12) Patent Application Publication
(10) Pub. No.: US 2018/0333633 A1
(43) Pub. Date: Nov. 22, 2018

(54) LAMINATE STRUCTURE FOR SKATEBOARD DECK

(71) Applicant: Casey Kelly, Paso Robles, CA (US)

(72) Inventor: Casey Kelly, Paso Robles, CA (US)

(21) Appl. No.: 15/601,798

(22) Filed: May 22, 2017

(51) Int. Cl. A63C 17/01; B32B 7/12; B32B 37/24; B32B 38/14

(52) U.S. Cl. CPC A63C 17/017; B32B 7/12; B32B 37/24; B32B 2605/00; B32B 2255/00; B32B 2307/4023; B32B 2037/243; B32B 38/14

(57) ABSTRACT

A laminate structure for a skateboard deck including a transparent top plate laminated to a transparent bottom plate. The lamination method includes applying a liquid solvent cement to an inner surface of the bottom plate, applying paint in a decorative effect to the cement, and then placing the top plate onto the bottom plate, creating a cement layer between the two plates. The paint is then viewable through the plates, creating a decorative effect. In other embodiments one or both plates are engraved prior to lamination.

### BACKGROUND OF THE INVENTION

### Field of the Invention

The present invention relates generally to laminate structures, and more specifically to plastic laminate structures. Even more specifically, the present invention relates to plastic laminate structures used in skateboard decks.

### Discussion of the Related Art

Conventional skateboards generally comprise an elongated board (the “deck”) coupled to two metal trucks which connect the wheels to the deck. Skateboard decks are typically 7-10.5 inches wide and 28-33 inches long. Decks are typically a laminate structure made from layers of Maplewood veneer and glue. However, wood decks may be subject to Decks may also be made of composites, aluminum, nylon, Plexiglas, fiberglass, plastics, foam, and other artificial materials. Skateboard decks may be flat or the ends may be upturned.

Skateboard decks are commonly used as a surface to showcase designs and/or decorative patterns. The design may be intended for view from the top of the deck or the bottom of the deck. For wood skateboard decks, the top of the deck is commonly covered in a non-decorated grip surface and the underside of the deck is decorated, either comprising a permanent decoration applied by the manufacturer or a temporary/semi-permanent decoration applied by the user (e.g. stickers). For decks including a transparent layer, the decoration may be applied to an interior portion of the transparent layer and still be viewable by the user.

### SUMMARY OF THE INVENTION

In one embodiment, the invention can be characterized as a laminate structure comprising: a first plate; and a second plate laminated to the first plate by a cement layer interposed between the first plate and the second plate, wherein at least one of the first plate and the second plate are transparent, the cement layer including a liquid cement which is generally transparent after setting, and a first paint layer having a first color, whereby the first color is viewable through the at least one transparent plate.

In another embodiment, the invention can be characterized as a method for making a laminate structure, including the steps of: spreading cement on an inner surface of a top plate; applying a first paint having a first color to the cement, wherein the first paint and the cement comprise a cement layer; placing a bottom plate onto the top plate, whereby the cement layer is interposed between the top plate and the bottom plate and the cement layer is juxtaposed with an inner surface of the bottom plate; and curing the cement.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a perspective view of a skateboard including a decorated laminate structure deck in one embodiment of the present invention.

FIG. 2 is a cross sectional view of the decorated laminate structure deck of FIG. 1.

FIG. 3 is a perspective view of a skateboard including an engraved laminate structure deck in another embodiment of the present invention.

FIG. 4 is a cross sectional view of the engraved laminate structure deck of FIG. 3.

FIG. 5 is a flowchart of a method for making a decorated laminate structure.

FIG. 6 is a flowchart of a method for making an engraved laminate structure.

FIG. 7 is a plan view of a decorated laminate structure deck wherein the decorations includes mixing of colors.

FIG. 8 is a plan view of a decorated laminate structure deck wherein the decorations include pressure feathering and air bubbles.

FIG. 9 is a cross sectional view of a laminate structure in another embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

[Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

While reference is made to a top plate and a bottom plate in the description as applied to a skateboard deck, it will be understood that in other applications of the invention in the finished use the laminate structure may be used with the boards in any orientation, e.g. the bottom plate may be the upmost plate, the plates may be oriented generally vertically, etc.

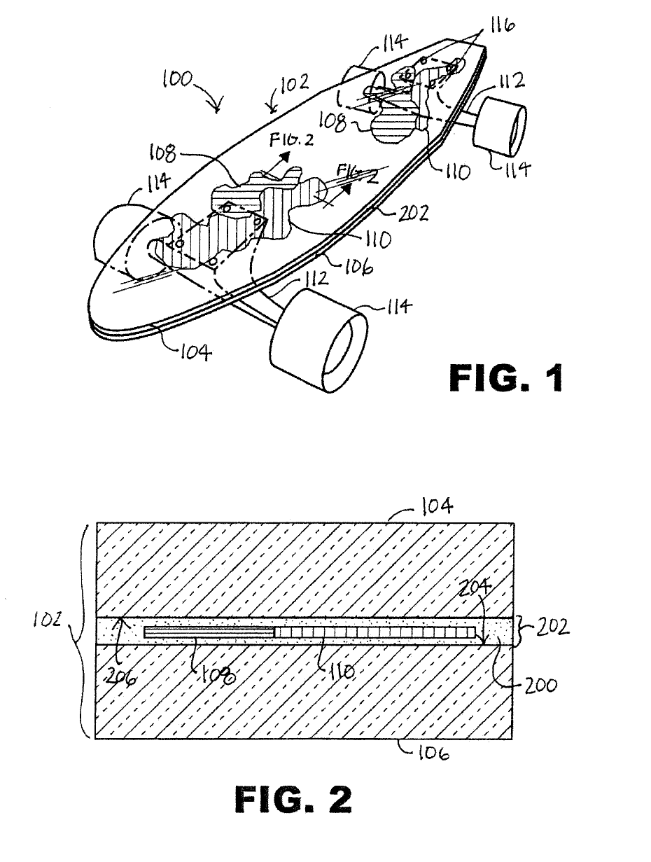

Referring first to FIG. 1, a perspective view of a skateboard 100 including a decorated laminate structure deck 102 is shown. Shown are a top plate 104, a bottom plate 106, a first paint layer 108, a second paint layer 110, two trucks 112, a plurality of wheels 114, and a plurality of hardware 116.

The skateboard 100 in the embodiment shown in FIG. 1 is as commonly known in the art, with the underside of the generally horizontally-oriented deck p102 coupled to two trucks 112. The deck 102 is substantially in the shape of an elongated oval. Each truck 112 is coupled to an underside of the deck 102 (with one truck 112 near a front portion of the skateboard 100 and the other truck 112 near a rear portion of the skateboard 100) and includes two wheels 114, whereby the skateboard 100 is configured to roll on the ground with the deck 102 substantially parallel to the ground. In some embodiments portions of the deck 102 may be angled; one common configuration is for the front portion and the rear portion to be angled upwards with respect to a middle flat portion of the deck 102. While the deck 102 is depicted flat herein for clarity, it will be understood that the deck 102 may be shaped as described above or in other skateboard deck shapes as known in the art. It will be also be understood that in other embodiments one of the top plate 104 and bottom plate 106 comprising the deck 102 may be opaque. While a traditional skateboard deck is shown in FIGS. 1 and 3, other types and configurations of skateboards and skateboard decks may be used with the laminate structure and methods described herein.

The decorated laminated structure deck 102 of FIG. 1 comprises the top plate 104 and the bottom plate 106, which are laminated together to form the laminate structure comprising the laminated structure deck 102. In the embodiment shown, both the top plate 104 and the bottom plate 106 are generally transparent, whereby the trucks 112 and wheels 114 are visible through the deck 102, as shown in FIG. 1. In one embodiment, the top plate 104 and the bottom plate 106 comprise polycarbonate. In other embodiments cell-cast or extruded acrylic or other suitable transparent or translucent plastic is used. The top plate 104 and the bottom plate 106 have a thickness suitable for skateboard functions when laminated together and included in the skateboard 100. In the present embodiment, the top plate 104 and the bottom plate 106 thicknesses are the same and are ½″ to ⅝. In other embodiments the top plate 104 and the bottom plate 106 may have other thicknesses depending on the intended use of the skateboard 100, the type of material used, etc. In some embodiments the thicknesses of the top plate 104 and the bottom plate 106 may be different.

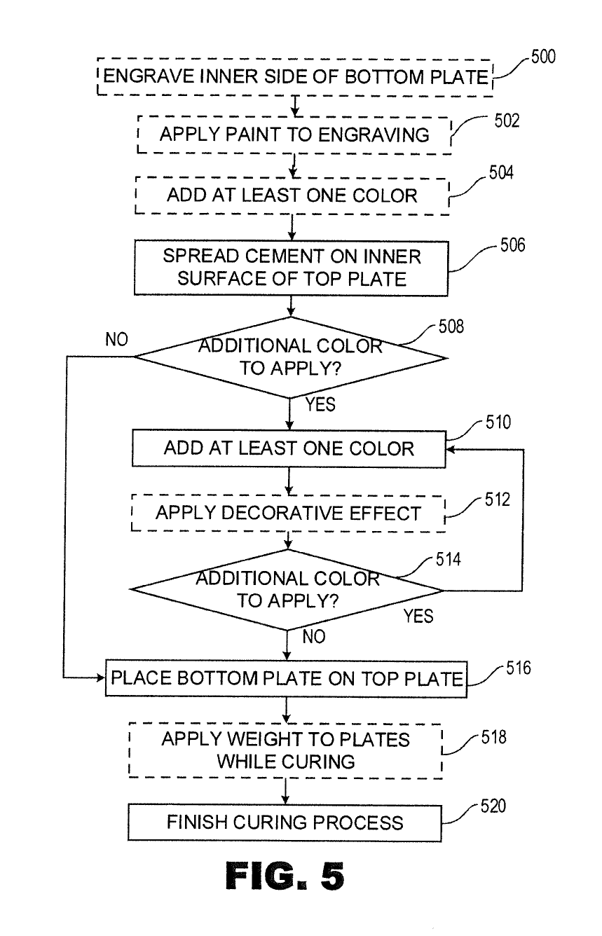

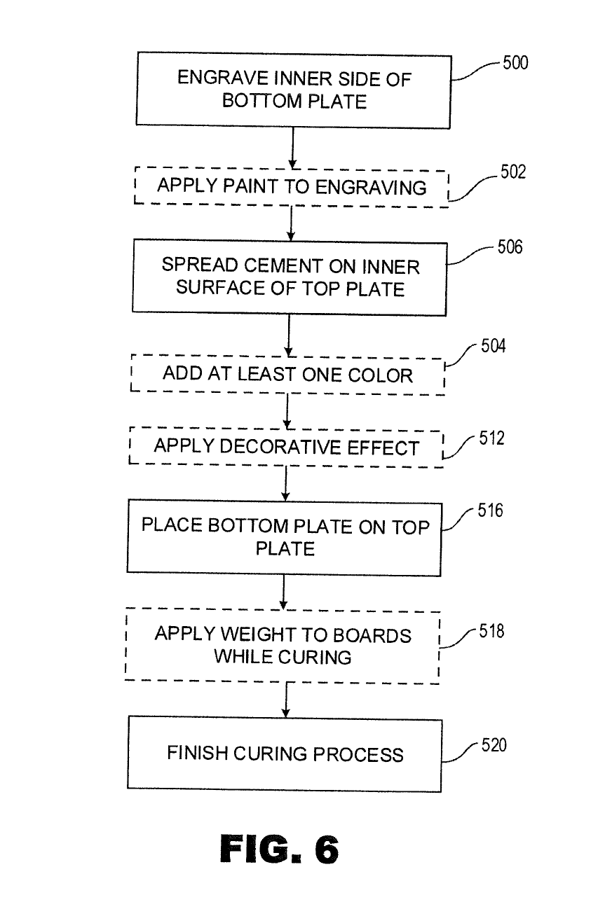

The top plate 104 and the bottom plate 106 are laminated together to form an integral structure. In the present embodiment, the polycarbonate plates 104 106 are laminated using a liquid solvent cement 200 configured for bonding polycarbonate. The cement 200 is also configured to be generally transparent after during. The cement 200 is generally spread across the entire surface to be laminated, either to one or both pieces. As the cement 200 cures, it forms a chemical bond with each piece, and also hardens, forming a thin cement layer 202 joining the two pieces (in this case the top plate 104 and the bottom plate 106) in an integral structure. The laminated process of the present invention is described further below in FIGS. 5 and 6.

In the present invention, the lamination of the top plate 104 to the bottom plate 106 also includes the addition of the first paint layer 108 having a first color and the second paint layer 110 having a second color different from the first color, during the spreading of the cement 200. The result is the first paint layer 108 and the second paint layer 110 are included in the final cement layer 202, whereby a decorative aspect is formed by the first color and the second color being visible (viewable) through each transparent plate while the remainder of the cement layer 202 (the cement 200) is also generally transparent.

Referring next to FIG. 2, a cross-sectional view of a portion of the decorated laminate structure deck 102 of FIG. 1 is shown. Shown are the top plate 104, the bottom plate 106, the first paint layer 108, the second paint layer 110, the cement 200, the cement layer 202, a bottom plate inner surface 204, and a top plate inner surface 206.

While for illustrative purposes the cement 200, the second paint layer 110, and the first paint layer 108 are shown as distinct areas, it will be understood that the liquid solvent cement 200, the first paint layer 108 and the second paint layer 110, being liquid upon application, will generally mix at boundary locations between the different liquids. In fact, such mixing may be desirable as for creating a third color by mixing the first paint layer 108 with the second paint layer 110 while applying to the top plate 104 or bottom plate 106.

During the lamination process for the decorated laminate structure deck 102, as described further below in FIGS. 5 and 6, the top plate 104 is laminated to the bottom plate 106 using a combination of the cement 200 and at least one paint layer, where the paint layer comprises paint or a mixture of paint and cement. In the example of FIGS. 1 and 2 two paint layers 108 110 are used, but it will be understood that one, two, three or more different paint layers can be applied.

In the embodiment shown in FIGS. 1 and 2, the combination of the cement 200, the first paint layer 108, and the second paint layer 110 form the cement layer 202 between the top plate 104 and the bottom plate 106. The cement layer 202 has a generally consistent thickness. As further described below in FIG. 5, the cement 200 is generally first applied to the bottom plate inner surface 204 (i.e. the surface that will be interior when the laminate is completed), with the first paint layer 108 and the second paint layer 110 then applied on top of the cement 200 in a decorative shape or pattern. The decorative pattern shown in FIG. 1 is an abstract pattern, but representational patterns or decorations may also be used. The bottom plate 106 is then placed on the cement layer 202, sandwiching the cement layer 202 between the top plate 104 and the bottom plate 106. In other embodiments, the first paint layer 108 and/or the second paint layer 110 can extend the entire thickness of the cement layer 202. In yet other embodiments, paint layers 108 110 can be applied to the top plate 104 such that at least in portions the paint layer 108 110 extends through the entire thickness of the cement layer 202. In a typical embodiment, the thickness of the cement layer 202 is 0.07-0.13 inches.

If desired, an LED light source may be coupled to the skateboard 100 and configured to illuminate the design and/or any engraved portion, painted or non-painted (as described in FIG. 3). In one embodiment, the LED light source is coupled to an underside of the laminate structure deck 102. In another embodiment, the LED light source is included in the cement layer 202 during the construction of the laminate structure deck 102.

Referring next to FIG. 3, a perspective view of another embodiment of the skateboard 100 including an engraved laminate structure deck 302 is shown. Shown are the top plate 104, the bottom plate 106, the two trucks 112, the plurality of wheels 114, the plurality of hardware 116, and an engraved design 304.

The skateboard 100 of FIG. 3 comprises the top plate 104 and the bottom plate 106 laminated together via the cement layer 202 as in FIGS. 1 and 2. In the embodiment shown in FIG. 3, paint layers are not shown for clarity, but in some embodiments one or more paint layers could additionally be incorporated into the cement layer 202 (as described in FIG. 5) for the engraved laminate structure deck 302 of FIG. 3. The top plate 104 and the bottom plate 106 comprise generally transparent material, as in FIGS. 1-2.

The bottom plate 106 is engraved in the decorative engraved design 304, which in the exemplary engraved deck 302 of FIG. 3 depicts a representational pattern of a shark. The transparency of the top plate 104 and the bottom plate 106 allows the engraved design 304 to be viewed through the plates 104 106 (in other embodiments only one plate 104 106 may be transparent). In the embodiment shown, a surface of the engraved design 304 is painted. The cement layer 202 extends into the engraved design 304, when the top plate 104 is laminated to the bottom plate 106.

In the embodiment of FIG. 3, the bottom plate 106 comprises material compatible with the desired engraving. In the present embodiment, acrylic is used for the engraved bottom plate 106. The bottom plate 106 and top plate 104 thicknesses in the engraved skateboard embodiment are approximately ⅝″ to ½″ thick.

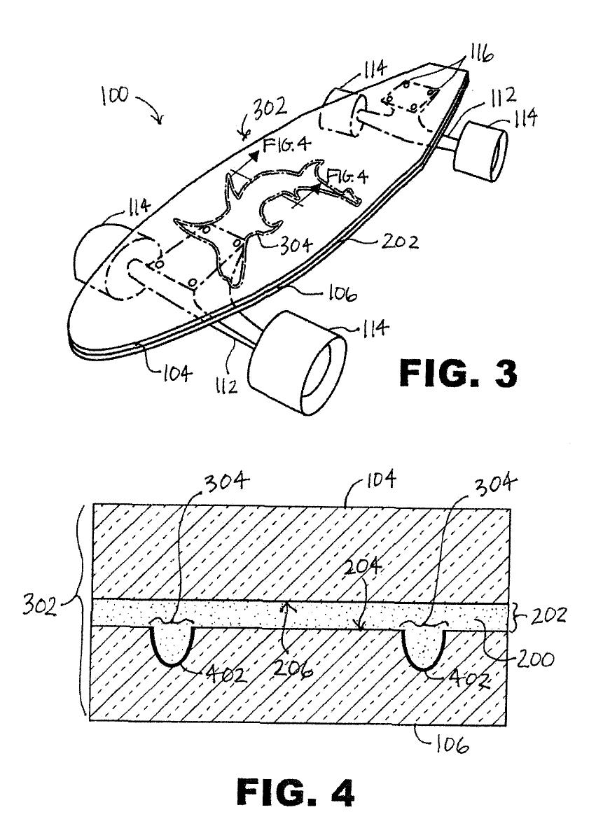

Referring next to FIG. 4, a cross-sectional view of a portion of the engraved laminate structure deck 302 of FIG. 3 is shown. Shown are the top plate 104, the bottom plate 106, the cement 200, the cement layer 202, the bottom plate inner surface 204, the top plate inner surface 206, the engraved design 304, and engraving paint layer 402.

As shown in FIG. 4, the cement layer 202 comprises the cement 200 between the top plate 104 and the bottom plate 106, including filling in the engraved channels of the engraved design 304. In the embodiment shown, prior to placing the cement 200, the engraved design 304 surfaces are painted with a layer of paint comprising the engraving paint layer 402. The paint layer 402 is optional and in one embodiment is used to make the engraved design 304 more visible

Referring next to FIG. 5, a method for making a decorated laminate structure, from two plates 104 106 is shown. The method may include optional engraving as shown in FIG. 3.

The first two steps are optional and are followed if engraving of the laminate structure is desired: the first engrave step 500 and the apply paint to engraving step 502. In the first engrave step 500, a design is engraved into what will be the inner (interior) side of the bottom plate 106 when the laminate is assembled (bottom plate inner surface 204). The engraving may be done using, any suitable method. In the exemplary method of FIG. 5, the engraving is done by using a Dremel® tool or other suitable type of rotary tool. In the skateboard deck 102 embodiment, an engraving depth is approximately 1/16″. In other applications of the laminate structure, the depth may be dependent on the material used and the thickness of the engraved plate. In some embodiments the engraving extends the entire thickness of the engraved plate.

In the next optional apply paint to engraving step 502, the engraved portion of the bottom plate 106 is painted with a thin paint layer 402 of colored paint (typically acrylic paint) to emphasize the design, as previously described in FIG. 4. The paint layer 402 is allowed to dry completely before continuing to the next step.

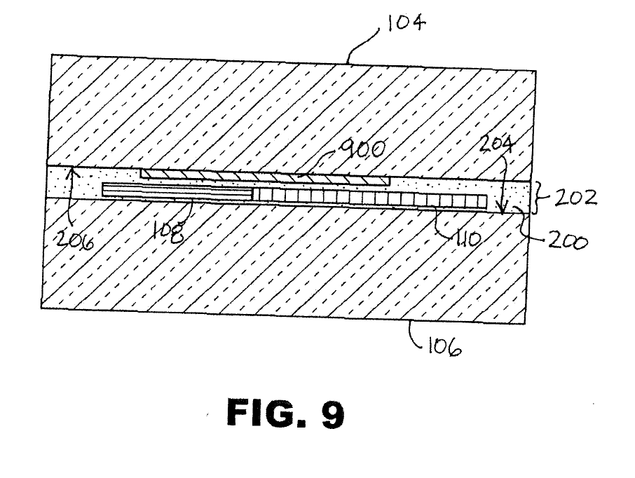

In the next (optional) add color step 504, if desired, paint of a color is first applied to the surface of the top plate 104 that will be the inner surface of the top plate 104 (top plate inner surface 206). An example of a laminate structure including paint added in the add color step 504 is shown below in FIG. 9. The paint in the present embodiment is acrylic paint, although other paint types compatible with the cement 200 and plate material may be used. In the present embodiment, paint is dripped onto the top plate inner surface 206 and spread using a spatula or trowel. For a typically-sized skateboard deck, drips of 1-7 ml are dripped at a time, until the desired amount of paint is added. Multiple colors of paint may be added during the add color step 504. Any portion of the top plate inner surface 206 may be covered with the paint, up to the entire top plate inner surface 206, although curing time may be affected. Application of the paint before the cement 200 application has the effect of causing the paint to bubble and smudge when the cement 200 is later applied, as opposed to the paint running and flowing when applied on top of the wet cement 200. A cross-sectional area of an exemplary laminate structure with paint applied directly to the top plate 104 is shown below in FIG. 9.

In the next spread cement step on top plate step 506, the cement 200 is spread over the top plate inner surface 206, or in the case where paint has already been applied in the add color step 504, over top of the applied paint. In one embodiment, the cement 200 is applied in a fanning motion from front to rear, and from side to side. In one embodiment, the cement 200 is first spread over at least 80% of the top plate inner surface 206. The top plate 104 is comprised of a plastic material compatible with the liquid solvent cement 200. If paint has already been applied in the add color step 504, the cement 200 is then mixed with the applied paint while applying in order to sufficiently bond to the top plate 104. Prior to proceeding to the place bottom plate step 516, the entire top plate inner surface 206 is covered by the cement 200 and/or the cement/paint mixture.

In the skateboard 100 embodiment shown in FIG. 1, approximately 2.5-5 ounces of cement 200 are used per deck 102. The amount of cement 200 used depends in part on the desired paint effects, for example, when pressure is used to create a decorative effect as in FIG. 8.

The method then proceeds to the first apply color decision point step 508. If it is desired to apply additional color or colors of paint after applying the cement 200, the process proceeds to the second add color step 510. If no additional colors are desired, the process skips to the place bottom plate step 516.

During the second add color step 510, while the cement 200 is still liquid, paint of a color is added to the applied cement 200. The paint may be the same color as in the first add color step 504 or may be a different color. The paint in the present embodiment is the same type of paint as in the first add color step 504, but in other embodiment may be a different type of paint compatible with the cement 200. In the present embodiment, the paint is dripped onto the applied cement 200. For a typically-sized skateboard deck, drips of 1-7 ml are dripped at a time, until the desired amount of paint is added. In one embodiment paint can be squeezed from a squeeze bottle as the bottle is moved over the top plate 104, creating a line of paint. The cement-to-paint ratio can be modified depending on the desired effect. In the present embodiment, the cement-to-paint ratio is within the range of 6.5:1 to 146:1.

In the next optional apply decorative effect step 512, a spatula or other implement is then used to spread the paint around on top of the cement 200. The spatula may be used to create various patterns. For example, the paint may by swirled, swiped in a zig-zag pattern, or placed in a substantially straight line. Other implements may be used to spread the paint, for example a brush. When the paint is applied on top of the cement layer 202, mixing the paint with the cement 200 will cause the paint to flow, creating gradient and fading effects. During the apply decorative effect step 512 two applied paint colors may be mixed to create a third color. During the apply decorative effect step 512 three applied paint colors, each applied to a different area of the top plate 104, are each individually swirled, and then the different colors are swirled together at the color boundaries.

In the next second apply color decision point 514, if at least one additional color is desired, the process returns to the second add color step 510 and another color of paint is added. If no additional colors are desired, the process proceeds to the place bottom plate step 516.

During the place bottom plate step 516, while the cement 200 has not set, i.e. is still in the condition for bonding, the bottom plate inner surface 204 is placed on the cement layer 202 (comprising the cement 200 and paint), interposing the cement layer 202 between the top plate 104 and the bottom plate 106. Typically, the amount of time between initial placing of the cement 200 and the place bottom plate step 516 is under 5 minutes. Addition of paint may lengthen the available working time of the cement 200.

In the optional apply weight to plates step 518, after the place bottom plate step 516, weight is applied to the plate assembly during curing. The weight may be used to increase the strength of the bond between the plates 104 106 and may also be used to create additional patterns in the cement layer 202. For example, a clamp applied at a location will force paint away from that location, forming a clear spot (as described further below in FIG. 8). The weight may also be used to curve the plate assembly. For example a 4.5″ outside diameter steel pipe may be used as a weight to curve the plate assembly.

In the final finish curing step 520, the cement 200 is allowed to cure according to the manufacturer's instructions. Clamps may be used during the finish curing step 520. After curing, the laminate structure may be cut into a skateboard deck shape (if for a skateboard deck) or other shape as determined by the intended application.

Referring next to FIG. 6, a method for making an engraved laminate structure from two plates 104 106 is shown. The steps are similar to those of FIG. 5, with the exception that additional paint is not added to the cement layer 202. It will be understood that various combinations of the methods of FIGS. 5 and 6 are also contemplated. While the method described engraves only the bottom plate 106, in other embodiments the top plate 104 may be engraved, or both plates 104 106 may be engraved.

In the first engrave step 500 an engraved design 304 is engraved into the bottom plate inner surface 204. The engraving may be done using any suitable method. In the exemplary method of FIG. 6, the engraving is done by using a Dremel® tool. In the skateboard deck embodiment, an engraving depth is approximately 1/16″. In other applications of the laminate structure, the depth may be dependent on the material used and the thickness of the bottom plate 106. In some embodiments the engraving extends the entire thickness of the bottom plate 106, and a backer to the bottom plate 106 is used to contain the cement 200 during cement application. Prior to use of the engraving tool, the design may be initially scratched out on the bottom plate inner surface 204.

In the next optional apply paint to engraving step 502, the engraved design 304 is painted with a thin paint layer 402 of colored paint to emphasize the engraved design 304 as previously described in FIG. 4. The paint layer 402 is allowed to dry completely before continuing to the next step.

In the following spread cement step on top plate step 506, the cement 200 is spread over the top plate inner surface 206. In one embodiment, the cement 200 is spread over at least 80% of the top plate inner surface 206. The top plate 104 is comprised of a plastic material compatible with the liquid solvent cement 200.

The process then proceeds to the place bottom plate step 516, while the cement 200 is still wet, the bottom plate inner surface 204 is placed on the cement layer 202, interposing the cement layer 202 between the top plate 104 and the bottom plate 106 and filling the engraved portion with the cement layer 202, as shown in FIG. 4

In the optional apply weight to plates step 518, after the place bottom plate step 516, weight is applied to the plate assembly during curing. The weight may be used to increase the strength of the bond between the plates 104 106 and may also be used to create additional patterns in the cement layer 202. For example, a clamp applied at a location will force paint away from that location, forming a clear spot. The weight may also be used to curve the plate assembly.

In the final finish curing step 520, the cement 200 is allowed to cure according to the manufacturer's instructions. After curing the laminate structure may be cut into a skateboard deck shape (i.e. for the laminated structure deck 102) or other shape as determined by the intended application.

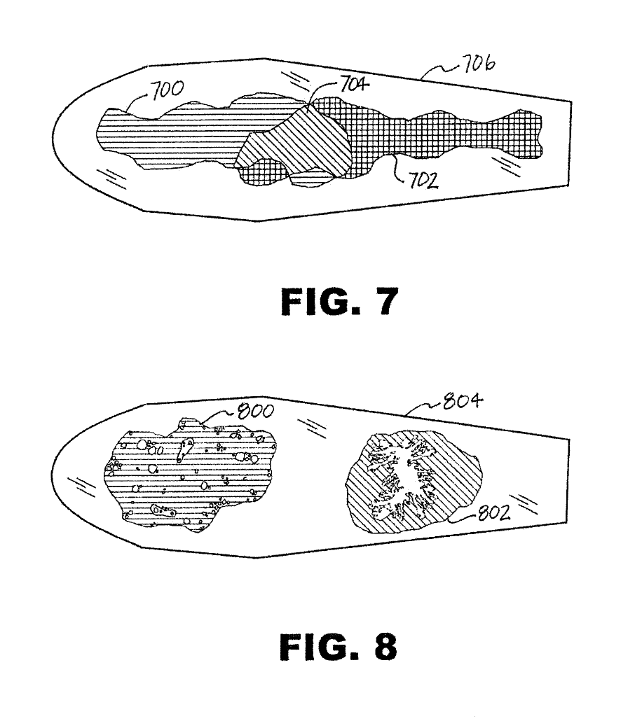

Referring next to FIG. 7, a plan view of an exemplary mixed color laminate structure deck wherein the decorations includes mixing of colors is shown. Shown are the mixed color laminate structure deck 706, a first mixing paint layer 700, a second mixing paint layer 702, and a mixed color layer 704.

As previously described in FIGS. 1 and 2, when more than one color of paint is applied to the cement layer 202, the paint may be mixed together to form a new color or colors. In the exemplary color mixed laminate structure deck 706 of FIG. 7, two paint colors have been applied, one at each end of the deck 706, and have been mixed in a center area of the deck 706 to form a third color. In the present example, the first mixing paint layer 700 uses blue paint, and the second mixing paint layer 702 uses yellow paint. The resulting mixed color layer 704 is then green. While the boundaries between the color layers 700 702 704 are shown to be defined, it will be understood that in most cases the mixing will includes gradient areas between colors. In some embodiments a gradient effect may be desired.

Referring next to FIG. 8, a plan view of a decorated laminate structure deck wherein the decorations include pressure feathering and air bubbles is shown. Shown are the bubbled/feathered laminate structure deck 804, a bubbled paint layer 800 and a feathered paint layer 802.

The bubbled paint layer 800, where air bubbles are incorporated into the paint layer 800, can be achieved by the natural tendency for trapped air to form bubbles in the cement layer 202 when the bottom plate 106 is placed on the top plate 104. The amount of air bubbles may be increased by applying the paint to the top plate 104 before adding the cement 200, as in the first add color step 504 of FIG. 5. Placing the bottom plate 106 directly down onto the top plate 104 will result in larger air bubbles in the cement layer 202. Placing the bottom plate 106 on the top plate 104 and then moving the bottom plate 106 side-to-side will level the cement layer 202 and result in fewer large bubbles. To achieve smaller air bubbles, more cement 200 is applied and the bottom plate 106 is rotated onto the top plate 104, resulting in gradual contact across the cement layer 202 instead of simultaneous full contact (resulting in the large bubbles).

The feathered paint layer 802 is achieved by applying pressure to a localized region of the laminated structure during the apply weight to plates step 518 and/or the finish curing step 520. The pressure is typically applied using a clamp. The pressure of the clamp will push the away from the location of the clamp and into adjacent areas, as shown in FIG. 8. In some embodiments, the clamp may be applied at a first location, then removed and applied at a second location.

Referring next to FIG. 9, a cross-sectional view of an exemplary laminate structure is shown where paint is applied both to the top plate inner surface 206 and to the cement layer 202. Shown are the top plate 104, the bottom plate 106, the first paint layer 108, the second paint layer 110, the cement 200, the cement layer 202, the bottom plate inner surface 204, the top plate inner surface 206, and a third paint layer 900.

As described in the method of FIG. 5, in optional add color step 504 one or more paint colors can be added to the top plate 104 prior to applying of the cement 200. In the example illustrated in FIG. 9, the third paint layer 900 was applied directly to the top plate inner surface 206 during the add color step 504. In the exemplary laminate structure of FIG. 9, two additional paint colors, the first paint layer 108 and the second paint layer 110 are applied to the bottom plate 106 via the cement 200.

While the invention herein disclosed has been described by means of specific embodiments, examples and applications thereof, numerous modifications and variations could be made thereto by those skilled in the art without departing from the scope of the invention set forth in the claims.

What is claimed is:

1. A laminate structure comprising:
a first plate; and
a second plate laminated to the first plate by a cement layer interposed between the first plate and the second plate, wherein at least one of the first plate and the second plate are transparent, the cement layer including a liquid cement which is generally transparent after setting, and a first paint layer having a first color, whereby the first color is viewable through the at least one transparent plate.

2. The laminate structure of claim 1, the cement layer further including a second paint layer having a second color, whereby the second color is viewable through the at least one transparent plate.

3. The laminate structure of claim 1, wherein a portion of the first paint layer is mixed with a portion of the second paint layer.

4. The laminate structure of claim 1, wherein the first plate and the second plate comprise polycarbonate.

5. The laminate structure of claim 1, wherein the first plate and the second plate comprise acrylic.

6. The laminate structure of claim 1, wherein the first paint layer comprises acrylic paint.

7. The laminate structure of claim 1, wherein the first paint layer forms a color gradient

8. The laminate structure of claim 1, wherein the first paint layer includes air bubbles

9. The laminate structure of claim 1, wherein the laminate structure is curved.

10. The laminate structure of claim 1, wherein the laminate structure is configured to be used as a deck for a skateboard.

11. The laminate structure of claim 1, wherein the first paint layer includes a decorative effect.

12. The laminate structure of claim 11, the decorative effect including at least one of swirling, zig-zag, and fading.

13. A method for making a laminate structure, including the steps of:
spreading cement on an inner surface of a top plate;
applying a first paint having a first color to the cement, wherein the first paint and the cement comprise a cement layer;
placing a bottom plate onto the top plate, whereby the cement layer is interposed between the top plate and the bottom plate and the cement layer is juxtaposed with an inner surface of the bottom plate; and
curing the cement.

14. The method for making the laminate structure of claim 13, including the step of:
applying, after applying the first paint, a second paint having a second color, wherein the cement layer includes the second paint.

15. The method for making the laminate structure of claim 13, including the step of:
prior to placing the bottom plate on the top plate, engraving a design on the inner surface of the bottom plate.

16. The method for making the laminate structure of claim 15, including the step of:
prior to placing the bottom plate on the top plate, painting the engraved design.

17. The method for making the laminate structure of claim 13, including the step of:
prior to spreading the cement, applying a second paint having a second color to the inner surface of the top plate.

18. The method for making the laminate structure of claim 13, including the step of:
after applying the paint, applying a decorative effect.

19. The method for making the laminate structure of claim 18, the decorative effect including at least one of swirling, zig-zag, and fading.

20. The method for making the laminate structure of claim 13, further comprising the step of:
prior to curing, applying pressure to a location of the laminate structure, whereby a decorative effect is achieved.
